(19) United States
(12) Patent Application Publication
(10) Pub. No.: US 2014/0065035 A1
(43) Pub. Date: Mar. 6, 2014

(54) METHOD FOR MANUFACTURING A MICROVALVE DEVICE MOUNTED ON A LAB-ON-A-CHIP, AND MICROVALVE DEVICE MANUFACTURED BY SAME

(71) Applicant: Mun-tak Son, Gyeongju-si (KR)

(72) Inventor: Mun-tak Son, Gyeongju-si (KR)

(73) Assignee: BIO FOCUS CO., LTD., Uiwang-si, Gyeonggi-do (KR)

(21) Appl. No.: 14/112,134

(22) PCT Filed: Apr. 18, 2012
(86) PCT No.: PCT/KR2012/002947

§ 371 Date: Oct. 16, 2013

(30) Foreign Application Priority Data
Apr. 19, 2011 (KR) 10-2011-0036222
Apr. 16, 2012 (KR) 10-2012-0038887

(51) Int. Cl. B01L 3/00

(52) U.S. Cl. CPC B01L 3/502707
USPC 422/502; 29/831

(57) ABSTRACT

The present invention relates to a method for manufacturing a microvalve device of a lab-on-a-chip by interposing a polyvinylidene chloride film between upper and lower substrates, each of which is produced by injection molding of a rigid polymer resin, and heating and pressurizing the resultant structure. The present invention also relates to a microvalve device manufactured by the method. According to the method of the present invention, each of the upper and lower substrates can be produced by injection molding of a rigid polymeric material, thus being appropriate for mass production in a short time. Excellent thermal bonding properties between the polyvinylidene chloride film and the substrates enable the formation of the rigid substrate/film membrane/rigid substrate structure in an easy and reliable manner, which shortens the time required to manufacture the microvalve device. Therefore, the method of the present invention is suitable for the mass production of labs-on-a-chip. In addition, the polyvinylidene chloride film does not droop upon thermal pressing due to its thermal shrinkage. Therefore, the polyvinylidene chloride film does not fill a fine shape and the shape thereof remains unchanged. The shape of the film membrane is curved by the application of a vacuum, which ensures smooth and sensitive opening/closing operations. The polyvinylidene chloride film prevents mixing of fluids flowing on and under the film membrane due to its low fluid permeability. Therefore, the polyvinylidene chloride film is suitable as a valve or pump.

### TECHNICAL FIELD

The present invention relates to a method for manufacturing a microvalve device of a lab-on-a-chip by interposing a polyvinylidene chloride film between upper and lower substrates, each of which is produced by injection molding of a rigid polymer resin, and heating and pressurizing the resultant structure. The present invention also relates to a microvalve device manufactured by the method.

### BACKGROUND ART

A specific disease can be diagnosed by measuring the concentration of a particular substance in a liquid sample taken from a living body.

Such diagnostic tests have been conducted through a series of complicated processes in laboratories by skilled technicians. With the current advance of technology, the processes can be performed on labs-on-a-chip.

Labs-on-a-chip are chips that use substrates having sub-nanometer microchannels made of various materials, such as plastics, glass and silicone. Labs-on-a-chip can promptly replace traditional experimental or research procedures in laboratories despite the presence of very small amounts of samples or specimens.

Various types of labs-on-a-chip are known. However, only a few labs-on-a-chip, such as DNA chips and rapid immunodiagnostic test kits, are commercially successful. Particularly, rapid immunodiagnostic test kits enable rapid diagnosis and are very convenient to use because optical or electrical signals are generated and read in a few minutes after liquid samples taken from humans are injected into the kits.

A lab-on-a-chip has a structure consisting of chambers, upper and lower substrates having microfluidic channels, and a microvalve film membrane mounted between the upper and lower substrates. The microvalve film membrane is generally made of polydimethylsiloxane (PDMS) as a flexible silicone resin.

More specifically, a very thin silicone membrane is obtained by spin coating a flexible silicone resin taking advantage of the fact that the flexible silicone resin exists in the form of a low-viscosity solution at room temperature, and is then interposed between two upper and lower fluid substrates. Thereafter, the silicone membrane is bonded to the substrates using oxygen plasma to form a three-layer structure.

That is, a liquid flows in the upper substrate, a gas flows in the lower substrate, and the thin film membrane is present between flow channels through which the two fluids flow to prevent the fluids from mixing. When high-pressure air is applied to the gas flow channel of the lower substrate, the membrane swells to block the liquid flow channel. When the high-pressure air is released, the liquid flow channel is opened. The opening/closing operations realize a microvalve.

Based on this principle, the membrane performs a role as a diaphragm. As a result, the lab-on-a-chip can also function as a micropump.

The use of the flexible silicone resin enables the formation of a microvalve in a simple and reliable manner but requires a long curing time to form the silicone membrane. Further, the liquid resin is not easy to handle, making it difficult to produce lab-on-a-chips on an industrial scale.

For these reasons, methods for the production of labs-on-a-chip using injection-molded articles of highly transparent polymer resins such as polyacrylate or polycyclic olefin copolymers are being actively investigated in some countries, particularly in Germany.

However, such methods are appropriate for the mass production of labs-on-a-chip but have a disadvantage in that it is difficult to produce multilayer substrates because the polymer resins are rigid materials, unlike flexible silicone, making it difficult to form microvalves.

Many attempts have been made to solve the above problems. For example, Korean Patent Publication No. 2006-0115429 discloses a lab-on-a-chip as a single chip having a multilayer adhesion structure of films. Each of the films has a microfluidic channel connected to match a sample inlet, a sample outlet, and a passage upon lamination. Each of the films is made of a polymer selected from polymethyl methacrylate, polystyrene, polyethylene, polypropylene, and polyethylene terephthalate. The films are adhered using an adhesive or bonded under heat and pressure.

The lab-on-a-chip can be produced by subjecting the films to continuous processes, including transfer, perforation, surface treatment, adhesion, and cutting, to form precise micropatterns. Accordingly, the lab-on-a-chip can be easily produced with more precise and efficient processes, thus being suitable for mass production.

Although continuous processes of the films corresponding to substrates and a valve are effective for the mass production of lab-on-a-chips, it is difficult to optimize the films so as to have required physical and chemical properties. If the film is made of a flexible material, it is stretched under heat and pressure and is no longer operated as a valve. Thus, if the film is adhered using an adhesive at room temperature, tight sealing is not obtained and adhesion requires a long time. Meanwhile, if the film is made of a rigid material, its poor flexibility makes it impossible to expect a precise operation.

Further, Korean Patent Publication No. 2011-0127059 discloses a microvalve device having a microvalve including a thin elastic film arranged between two substrates, and a valve sheet arranged in a fluidic channel on one of the substrates, and a method for manufacturing the microvalve device in a simple manner. The microvalve prevents the elastic film from being in contact with the valve sheet at ordinary times.

Specifically, the microvalve device includes: a first substrate having a first surface on which at least one flow channel and at least one valve sheet formed in the flow channel are arranged; a second substrate having a second surface on which at least one pneumatic channel and at least one air chamber are connected to each other; and an elastic film interposed between the first substrate and the second substrate. The upper portion of the valve sheet is lower than the first surface of the first substrate. The elastic film is composed of PDMS.

Due to the structure of the microvalve device, the elastic film is not in contact with the valve sheet at ordinary times. Accordingly, an additional process for permanently bonding the elastic film to the valve sheet is avoided, thus enabling the manufacture of the microvalve device in a simple manner. In addition, there is no risk that the elastic film may be permanently bonded to the valve sheet, leading to an increase in bonding strength between the elastic film and the two substrates in the manufacturing process.

The structure of the microvalve device is specially shaped such that the bonding operation between the elastic film and the substrates can be simply carried out, leading to time saving. However, the use of PDMS as a material for the elastic film needs a long time to produce the elastic film.

In recent years, the market for labs-on-a-chip, particularly, disposable diagnostic chips, using polymer resins has been expanding gradually. Particularly, with the development of lab-on-a-chip technology, disposable labs-on-a-chip are strongly needed in the field of medical diagnostic devices. Under such circumstances, there is an urgent need for advanced microvalve technology.

### DISCLOSURE

### Technical Problem

It is an object of the present invention to provide a lab-on-a-chip including substrates made of rigid polymer resins, which can be cured in a short time and can be produced by injection molding, and a film membrane bonded to the substrates in a simple and reliable manner, and a method for producing labs-on-a-chip on an industrial scale.

### Technical Solution

According to one aspect of the present invention, there is provided a method for manufacturing a microvalve device mounted on a lab-on-a-chip, the method including: injection molding rigid polymeric materials to produce a fluid circuit substrate 11 having a fluidic channel 14 and a gas circuit substrate 13 having a through-hole 15; interposing a polyvinylidene chloride film 12 between the fluid circuit substrate 11 and the gas circuit substrate 13; applying a vacuum to the through-hole 15 of the gas circuit substrate 13; and thermally pressing the resulting structure in which the fluid circuit substrate 11, the polyvinylidene chloride film 12, and the gas circuit substrate 13 are sequentially laminated, under high temperature and high pressure conditions.

The thermal pressing is preferably performed at a pressure of 4 to 30 atm and a temperature of 80 to 120° C., and the vacuum is preferably from 0.05 to 50 torr.

The fluid circuit substrate 11, the gas circuit substrate 13, and the polyvinylidene chloride film 12 are preferably surface treated with oxygen plasma.

According to another aspect of the present invention, there is provided a microvalve device 10 mounted on a lab-on-a-chip and manufactured by the method, the microvalve device 10 including an upper fluid circuit substrate 11 made of a rigid polymeric material, a lower gas circuit substrate 13 made of a rigid polymeric material, a curved polyvinylidene chloride film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.

### Advantageous Effects

According to the method of the present invention, each of the upper and lower substrates can be produced by injection molding of a rigid polymeric material, thus being appropriate for mass production in a short time. Excellent thermal bonding properties between the polyvinylidene chloride film and the substrates enable the formation of the rigid substrate/film membrane/rigid substrate structure in an easy and reliable manner, which shortens the time required to manufacture the microvalve device. Therefore, the method of the present invention is suitable for the mass production of labs-on-a-chip.

In addition, the polyvinylidene chloride film does not droop upon thermal pressing due to its thermal shrinkage. Therefore, the polyvinylidene chloride film does not fill a fine shape and the shape thereof remains unchanged. The shape of the film membrane is curved by the application of a vacuum, which ensures smooth and sensitive opening/closing operations. The polyvinylidene chloride film prevents mixing of fluids flowing on and under the film membrane due to its low fluid permeability. Therefore, the polyvinylidene chloride film is suitable as a valve or pump.

### DESCRIPTION OF DRAWINGS

FIG. 1 illustrates cross-sectional views of the structure of a microvalve device according to the present invention.

FIG. 2 illustrates various shapes of a film membrane formed in a microvalve device.

FIG. 3 is a view schematically illustrating a method for manufacturing a microvalve device of the present invention in which substrates are bonded to a film membrane by thermal pressing under a vacuum.

FIG. 4 illustrates a lab-on-a-chip according to an exemplary embodiment of the present invention, FIG. 5 shows an injection-molded article for a fluid circuit substrate of a lab-on-a-chip, and FIG. 6 is a photograph showing a driving state of a lab-on-a-chip.

### EXPLANATION OF REFERENCE NUMERALS

10: Microvalve device, 11: Fluid circuit substrate, 12: Film, 13: Gas circuit substrate, 14: Fluidic channel, 15: Through-hole, 16: Film membrane, 20: Microchannel structure, 30: Micro diaphragm pump structure, 40: Microvalve structure

### BEST MODE

A microvalve device mounted on a lab-on-a-chip and a method for manufacturing the microvalve device according to the present invention will now be described in detail.

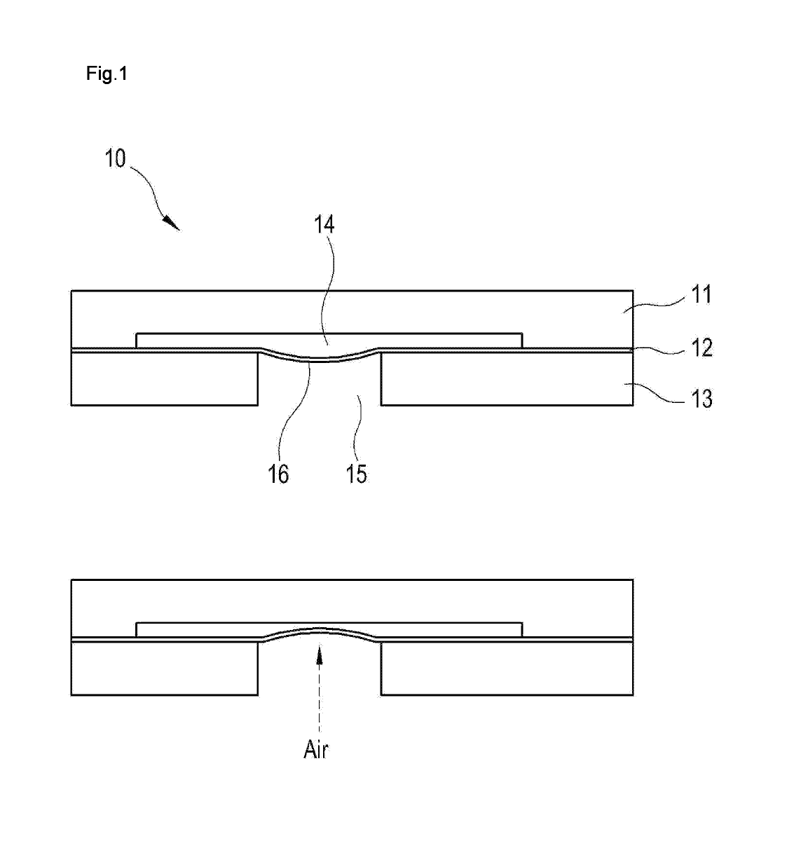

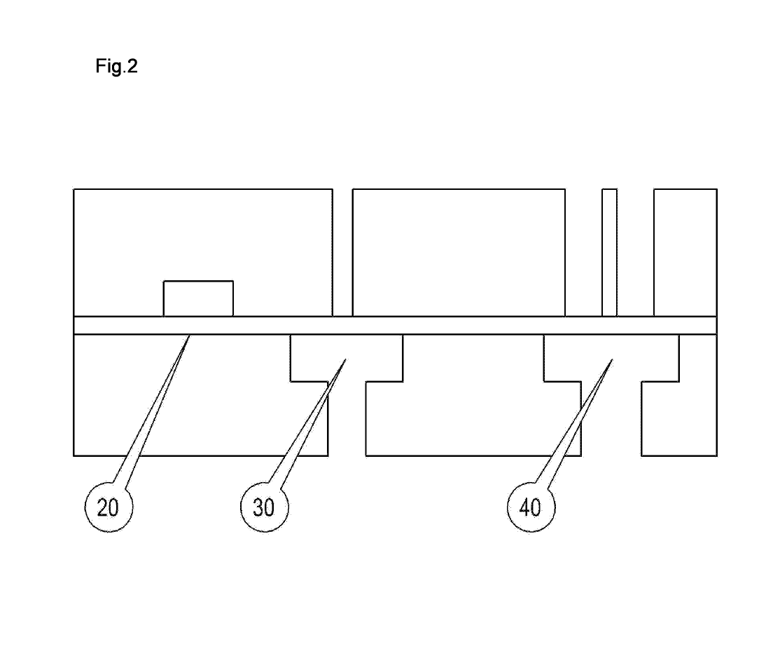

FIG. 1 illustrates schematic cross-sectional views of the structure of a microvalve device according to the present invention. In FIG. 1, the microvalve device is denoted by 10.

The microvalve device 10 includes an upper fluid circuit substrate 11, a lower gas circuit substrate 13, a film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.

Although not shown, the fluidic channel 14 of the microvalve device 10 is in communication with a plurality of chambers, including reagent chambers containing an antibody solution, a washing solution, a sample solution or a fluorescence labeling solution, a reaction chamber where the solutions of the reagent chambers react with each other, and an absorption chamber adapted to transfer the solutions, and the through-hole 15 and the absorption chamber are connected to an external pneumatic manifold to receive an air pressure or vacuum. The air pressure or vacuum opens/closes the film membrane 16. As a result, the solutions are transferred to construct a lab-on-a-chip for diagnosis.

As described above, the microvalve device 10 is a key element constituting the lab-on-a-chip and has a structure consisting of at least three layers, i.e. the film membrane 16 acting as a barrier membrane of a valve or a diaphragm of a pump, the upper substrate supporting the film membrane 16 and having the fluidic channel 14 through which a fluid moves, and the lower substrate supporting the film membrane 16 and having the through-hole 15 through which a gas moves. The three constituent layers are laminated on and bonded to each other.

The film membrane 16 is a key element constituting the microvalve device 10 and should be flexible, readily stretchable, and very tough enough to allow no leakage while withstanding vibration of many membranes for valve operation.

The most widely used lab-on-a-chip in laboratories has a typical structure consisting of a PDMS substrate, a PDMS membrane, and a PDMS substrate, which are made of flexible silicone materials and are easy to produce. The constituent layers can be permanently bonded to each other by oxygen plasma treatment. This bonding is sufficiently strong to withstand a considerably high pressure and to prevent no leakage. Due to these advantages, this structure is employed in most labs-on-a-chip.

The PDMS-made thin membrane has such ideal characteristics but curing of the flexible silicone requires at least 30 minutes, making it difficult to mass-produce labs-on-a-chip made of PDMS.

Thus, many solutions to replace PDMS with transparent rigid plastics, which can be produced on an industrial scale, have been proposed in recent years.

Transparent rigid materials, such as polymethyl methacrylate (PMMA), polypropylene (PP) polycarbonate (PC), and cyclic olefin copolymers (COC), are attracting attention as materials for the production of labs-on-a-chip on an industrial scale.

Film membranes for microvalves are required to be flexible, stretchable, and tough. However, these requirements are not yet met when thin film membranes are made of the rigid materials.

Further, flexible silicone membranes are not bonded to rigid plastics by any means and material, such as heat, pressure, adhesives, and organic solvents. Therefore, flexible silicone membranes are unsuitable for use in rigid plastic substrates and are applied only to microvalves having a PDMS substrate/PDMS membrane/PDMS substrate structure.

For these reasons, studies on labs-on-a-chip made of transparent rigid plastics are currently limited to bilayer structures having no interlayer membrane. Therefore, valves or pumps cannot be embedded and reagents are injected through a syringe pump from the outside.

A film membrane for a lab-on-a-chip may be produced using a transparent flexible polymeric material, such as polyvinyl chloride (PVC) or polyethylene (PE), instead of a flexible silicone material. In this case, when the thin film membrane is interposed between upper and lower plastic substrates and the resulting structure is heated and pressurized to attach the two substrates, PVC or PE as the material for the transparent flexible film is stretched by heat and pressure to fill the fluidic channel or gas flow channel finely engraved in the substrates. Therefore, the transparent flexible polymeric material cannot be used for labs-on-a-chip.

As a solution to the above problems, the microvalve device of the present invention uses polyvinylidene chloride (PVDC) as a material for the film membrane.

A film molded from polyvinylidene chloride meets requirements in terms of flexibility and toughness, which are characteristics required in microvalve membranes, and exhibits low thermal shrinkage and fluid permeability, thus being very suitable as a film membrane for a lab-on-a-chip.

In the microvalve device 10, a fluid passing through the fluidic channel 14 of the fluid circuit substrate 11 and a gas supplied to the through-hole 15 come into contact with each other through the film membrane 16. At this time, the moisture-barrier properties of the polyvinylidene chloride film further enhances the performance of the lab-on-a-chip.

Table 1 shows permeabilities of the polyvinylidene chloride film and other kinds of resin films.

TABLE 1

| | | | Water vapor |
|---|---|---|---|
| | Thickness | Oxygen permeability²⁾ | permeability³⁾ |
| Film kind | (μm) | (ml/m²/0.1 MPa/day) | (g/m²/day) |
| K-OPP¹⁾ | 23 | 4 | 4 |
| OPP | 20 | 1300 | 7-8 |
| Nylon | 15 | 80 | 300 |
| PET | 12 | 80 | 45 |
| LDPE | 40 | 2000 | 9-12 |
| HDPE | 40 | 1500 | 3-6 |
| CPP | 40 | 2000 | 6-12 |

Note
¹⁾20 μm OPP film with 3 μm coating of PVDC latex
²⁾JIS K7126B at 20° C., 70% RH
³⁾JIS K7129 at 40° C., 90% RH

In Table 1, K-OPP is a 20 μm thick oriented polypropylene film coated with 3 μm thick polyvinylidene chloride and has a water vapor permeability of 4 g/m²/day, which corresponds to about half that of the oriented polypropylene film (7-8), about 1/11 of that of polyethylene terephthalate (PET), and about 1/75 of Nylon.

The production of the polyvinylidene chloride film requires a short time to cure the resin, and thermal bonding properties between the polyvinylidene chloride film and a rigid material are excellent. Due to these advantages, a rigid substrate/polyvinylidene chloride film membrane/rigid substrate structure can be easily realized. Therefore, the microvalve device in which the polyvinylidene chloride film membrane is mounted can be manufactured in a short time, enabling the mass production of labs-on-a-chip.

A more detailed description will be given of the method for manufacturing the microvalve device having an upper substrate/film membrane/lower substrate laminate structure according to the present invention.

First, the polyvinylidene chloride film 12 is interposed between the upper substrate and the lower substrate, each of which is made of a transparent rigid material. Then, the resulting structure is thermally pressed under high temperature and high pressure conditions to manufacture the microvalve device. In the microvalve device, the upper substrate, the film membrane, and the lower substrate are sequentially laminated on and bonded to each other.

The thickness of the polyvinylidene chloride film 12 is not limited and may suitably be chosen according to the intended applications. Preferably, the polyvinylidene chloride film 12 has a thickness in the range of 5 to 30 μm. Within this range, the polyvinylidene chloride film 12 can sufficiently function as a valve or pump.

The thermal pressing is preferably performed at a pressure of 4 to 30 atm and a temperature of 80 to 120° C. Within this temperature range, the polyvinylidene chloride shrinks without drooping and is thus tightened.

FIG. 2 illustrates various shapes of the film membrane formed in the microvalve device.

The upper and lower substrates and the film membrane form basic three-layer structures of the microvalve device 40. Such three-layer structures include a microchannel structure 20, a micro diaphragm pump structure 30, and a microvalve structure 40. The polyvinylidene chloride film shrinks and is thus tightened during thermal pressing. Accordingly, the polyvinylidene chloride film does not droop, and as a result, no filling of a fine shape occurs. The shape of the polyvinylidene chloride film remains unchanged, as illustrated in FIG. 2.

However, the polyvinylidene chloride film is tightly stretched due to its thermal shrinkage during thermal pressing, and thus the film membrane loses its elasticity, making smooth and sensitive opening/closing of the valve impossible.

In view of these problems, a vacuum is created inside the microvalve device during hot pressing and bonding in the present invention. As a result, the film membrane undergoes extensional deformation.

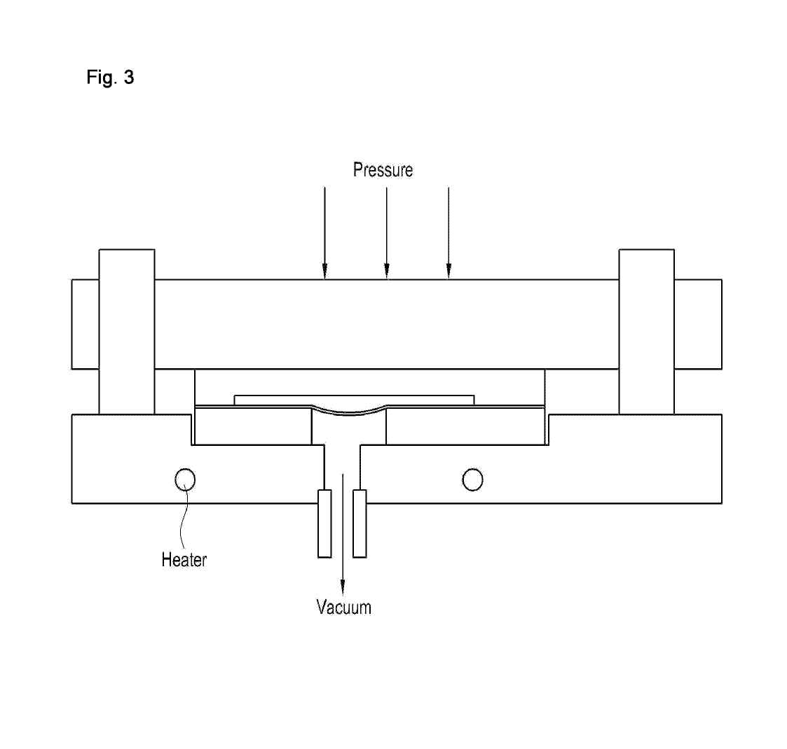

FIG. 3 is a view schematically illustrating the method for manufacturing the microvalve device of the present invention. Specifically, the upper substrate/polyvinylidene chloride film/lower substrate structure is mounted on a hot press and is thermally pressed and bonded by applying a vacuum thereto through the through-hole of the lower substrate.

When no vacuum is applied, the film membrane is tightened due to its thermal shrinkage and is thus attached to the upper substrate. When the lab-on-a-chip is gas-driven, the film membrane is extremely tightened, making smooth driving of the lab-on-a-chip difficult.

The degree of vacuum is preferably in the range of 0.5 to 50 torr but is not limited to this range. An appropriate vacuum is applied depending on the thickness of the film membrane or the valve size.

When a vacuum is applied to the through-hole of the lower substrate during bonding under heat and pressure, the film membrane undergoes extensional deformation into a curved shape. The deformed film membrane acting as a valve or diaphragm moves up and down by the gas pressure to block or open the fluidic channel of the upper substrate. That is, the film membrane functions as a microvalve.

It is preferred that the film membrane and the upper and lower substrates made of transparent rigid materials are surface treated with oxygen plasma at atmospheric pressure or vacuum. This surface treatment increases the bonding performance between the substrates and the film membrane in the laminate structure.

### MODE FOR INVENTION

The method for manufacturing the microvalve device of the present invention will be explained in more detail with reference to the following examples.

These examples are provided for illustrative purposes only and are not intended to limit the invention. It should be apparent to those skilled in the art that modifications and equivalents can be made without departing from the technical spirit of the invention.

1) A drawing of the lab-on-a-chip was designed using a CAD Program (Autocad 2010, AutoDesk Inc., U.S.A.).

2) The drawing was printed on a transparent film using a 1200 dpi image setter to construct a photomask.

3) A thick-film type photosensitizer (SU-8) was applied to a thickness of 50 μm onto a 4 inch silicon wafer, followed by spin coating and baking.

4) The photomask was put on the baked silicon wafer, which was then selectively cured by exposure to UV light.

5) The cured silicon wafer was dipped in a developing solution, cured by shaking, and washed.

6) The washed silicon wafer was placed in a gold sputtering chamber and was covered with a gold film.

7) The gold film-covered silicon wafer was placed in a nickel electroforming system where plating was performed to grow a 0.5 mm thick nickel layer.

8) The nickel layer was removed from the silicon wafer, and the edges of the silicon wafer were cut using a diamond wheel and trimmed using a rotating grindstone.

9) It was confirmed that a shape designed in a fine pattern formed on the nickel plate was engraved.

10) A quadrangular pocket and a guide hole were formed in a 15 mm thick aluminum block using a CNC milling machine.

11) The nickel plate was attached to the bottom of the pocket of the aluminum block using an epoxy resin.

12) A guide hole was formed in a 20 mm thick aluminum block and a sprue bush was attached thereto to construct a small-scale mold for injection molding.

13) The two aluminum blocks were fixed to a guide pin and placed on a small-scale vertical injection molding machine.

14) An acrylic resin was filled in a cylinder of the injection molding machine and was injection molded at a pressure of 10 atm to obtain a plastic substrate, which was then separated into a gas circuit substrate and a fluid circuit substrate.

15) A 15 μm thick polyvinylidene chloride film was interposed between the gas circuit substrate and the fluid circuit substrate to construct a laminate.

16) A pocket corresponding to the gas circuit substrate was formed in an aluminum block by CNC milling, and a through-hole was formed at a position of the aluminum block corresponding to the position of a through-hole previously formed in the gas circuit substrate.

17) The aluminum block constructed above was placed on a hot press and a vacuum pump was connected to the through-hole of the aluminum block.

18) The laminate constructed in step 15) was placed on the aluminum block of step 17), and the vacuum pump was operated to apply a low vacuum (100 mTorr) thereto.

19) The laminate was thermally pressed at a pressure of 30 atm and a temperature of 95° C. for 2 min. As a result of the thermal pressing, the layers of the laminate were tightly adhered to each other. The film was deformed into a curved diaphragm shape by the vacuum applied to the through-hole.

20) The laminate was taken out and placed on a testing stage on which a microscope was mounted, and a pneumatic hose was connected to the through-hole of the gas circuit substrate.

21) An air pressure was applied to the through-hole of the laminate and a microscopic observation was made as to whether the diaphragm was operated to close or open the fluid channel.

22) A red ink was injected into the fluid circuit substrate through a syringe pump and a microscopic observation was made as to whether the flow of the liquid was blocked or allowed.

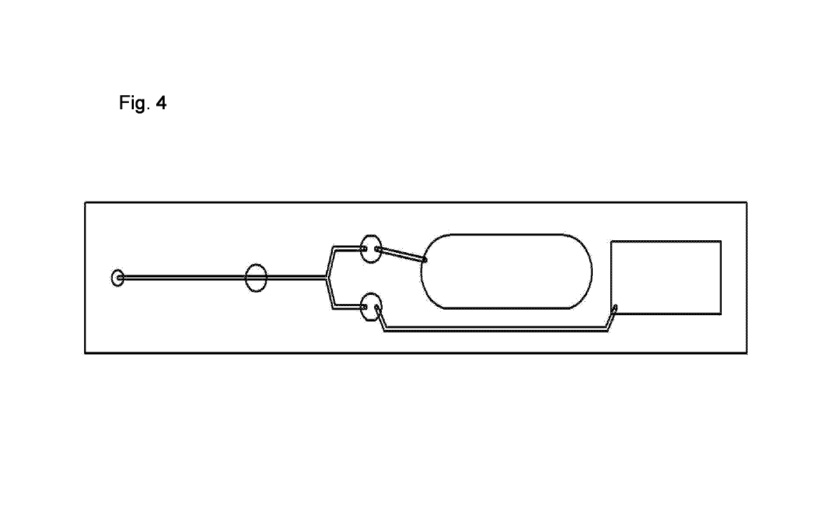

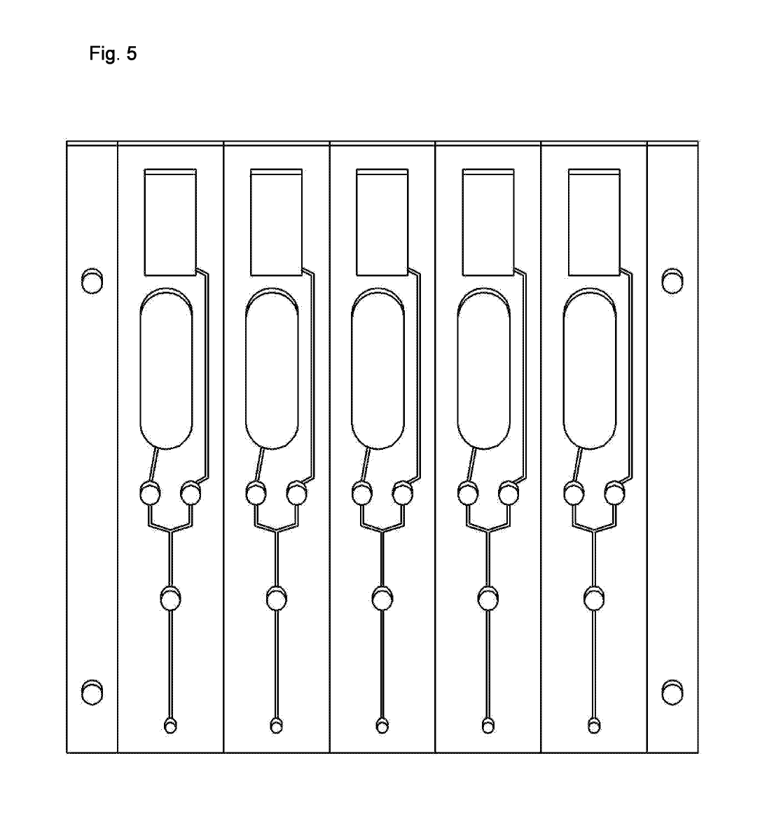

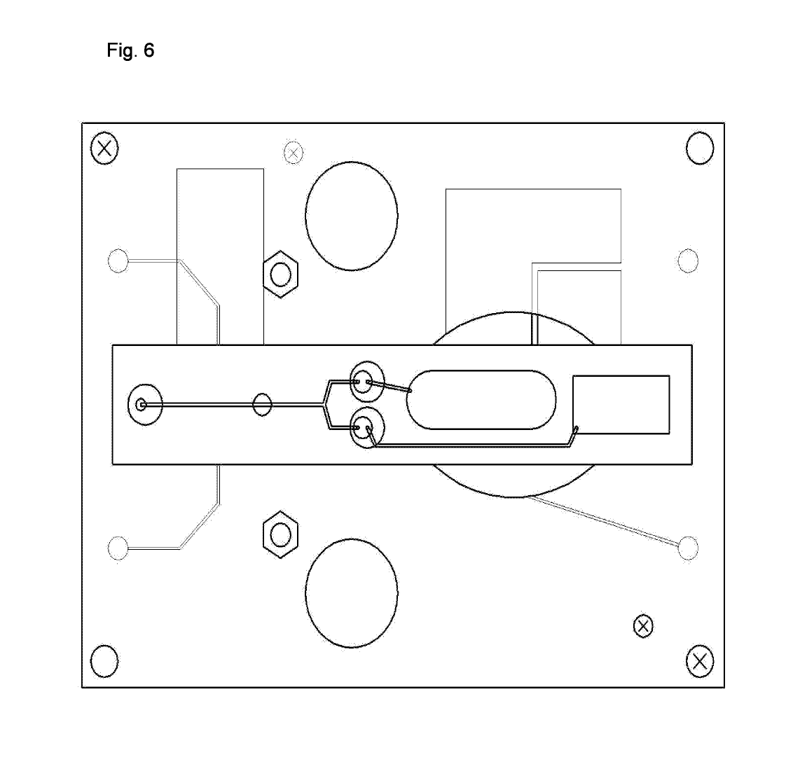

FIG. 4 illustrates an example of the lab-on-a-chip. FIG. 5 shows an injection-molded article for the fluid circuit substrate of the lab-on-a-chip. FIG. 6 is a photograph showing a driving state of the lab-on-a-chip.

### INDUSTRIAL APPLICABILITY

As is apparent from the foregoing, according to the method of the present invention, each of the upper and lower substrates can be produced by injection molding of a rigid polymeric material, thus being appropriate for mass production in a short time. Excellent thermal bonding properties between the polyvinylidene chloride film and the substrates enable the formation of the rigid substrate/film membrane/rigid substrate structure in an easy and reliable manner, which shortens the time required to manufacture the microvalve device. Therefore, the method of the present invention is suitable for the mass production of labs-on-a-chip.

In addition, the polyvinylidene chloride film membrane of the microvalve device according to the present invention is curved while maintaining its shape. This ensures smooth and sensitive opening/closing operations. The polyvinylidene chloride film prevents mixing of fluids flowing on and under the film membrane. Therefore, the polyvinylidene chloride film is suitable as a valve or pump.

1. A method for manufacturing a microvalve device mounted on a lab-on-a-chip, the method comprising:
injection molding rigid polymeric materials to produce a fluid circuit substrate 11 having a fluidic channel 14 and a gas circuit substrate 13 having a through-hole 15;
interposing a polyvinylidene chloride film 12 between the fluid circuit substrate 11 and the gas circuit substrate 13;
applying a vacuum to the through-hole 15 of the gas circuit substrate 13; and
thermally pressing the resulting structure in which the fluid circuit substrate 11, the polyvinylidene chloride film 12, and the gas circuit substrate 13 are sequentially laminated, under high temperature and high pressure conditions.

2. The method according to claim 1, wherein the thermal pressing is performed at a pressure of 4 to 30 atm and a temperature of 80 to 120° C.

3. The method according to claim 1, wherein the vacuum is from 0.05 to 50 torr.

4. The method according to claim 1, wherein the fluid circuit substrate 11, the gas circuit substrate 13, and the polyvinylidene chloride film 12 are surface treated with oxygen plasma.

5. A microvalve device 10 mounted on a lab-on-a-chip and manufactured by the method according to claim 1, the microvalve device 10 comprising an upper fluid circuit substrate 11 made of a rigid polymeric material, a lower gas circuit substrate 13 made of a rigid polymeric material, a curved polyvinylidene chloride film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.

6. A microvalve device 10 mounted on a lab-on-a-chip and manufactured by the method according to claim 2, the microvalve device 10 comprising an upper fluid circuit substrate 11 made of a rigid polymeric material, a lower gas circuit substrate 13 made of a rigid polymeric material, a curved polyvinylidene chloride film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.

7. A microvalve device 10 mounted on a lab-on-a-chip and manufactured by the method according to claim 3, the microvalve device 10 comprising an upper fluid circuit substrate 11 made of a rigid polymeric material, a lower gas circuit substrate 13 made of a rigid polymeric material, a curved polyvinylidene chloride film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.

8. A microvalve device 10 mounted on a lab-on-a-chip and manufactured by the method according to claim 4, the microvalve device 10 comprising an upper fluid circuit substrate 11 made of a rigid polymeric material, a lower gas circuit substrate 13 made of a rigid polymeric material, a curved polyvinylidene chloride film membrane 16 disposed between the fluid circuit substrate 11 and the gas circuit substrate 13, a fluidic channel 14 finely engraved in the fluid circuit substrate 11, and a through-hole 15 formed in the gas circuit substrate 13.
